(19) United States
(12) Patent Application Publication
(10) Pub. No.: US 2006/0003299 A1
(43) Pub. Date: Jan. 5, 2006

(54) Methods for training children to avoid abduction

(76) Inventor: Tom Patire, Elmwood Park, NJ (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/939,997

(22) Filed: Sep. 14, 2004

Related U.S. Application Data
(60) Provisional application No. 60/584,474, filed on Jul. 2, 2004.

(51) Int. Cl. G09B 19/00

(52) U.S. Cl. 434/247

(57) ABSTRACT

A method of training children to avoid abduction by becoming an “obstacle” to an abductor's success utilizes a training program that teaches a child techniques for physically defeating the abductor with learned motor skills and obstacle positioning. In addition, the child is trained to distract the abductor with acting techniques.

### RELATED APPLICATIONS

This application claims priority to provisional application No. 60/584,474, filed Jul. 2, 2004, entitled “Know and Go,” which is incorporated in its entirety by reference'in this specification.

### FIELD OF THE INVENTION

The invention is in the field of training children to avoid abduction. More particularly, the invention is in the field of training children to avoid abduction by a stranger.

### BACKGROUND AND PURPOSE OF THE INVENTION

Child abduction is a problem that occurs societies throughout the world. Children are often smaller and physically weaker than their abductors making them easy prey or easy marks. Abductors often select children as potential subjects for abduction based on whether a child appears cooperating or unskilled in avoiding abduction. There are a number of things a child can do to be an obstacle or to present obstacles to an abductor in the abduction process. While many responses of a child when facing a situation of abduction may seem instinctive, which may or may not improve the situation for the child, training a child to have a response that improves and even maximizes that child's chance of avoiding abduction is learnable though training.

Most abductions occur unexpectedly and in a very short period of time. The goal of most abductors is to efficiently, i.e., quickly and unnoticeably, abduct a child in order to avoid getting caught. The response of a child to an unexpected and fast occurring set of events is very important. The reaction of a child to the situation is probably the largest factor in whether the abduction succeeds as often the abductor chooses the circumstances for abduction such that the only or major obstacle to abduction is the child.

Training should instill in a child reactions to situations that become subconscious, i.e., become such in nature that the child does not even have to think of what the proper response is to the situation, but simply does the right thing. Losing time in thinking of a proper reaction can make the difference between a successful and an unsuccessful abduction.

Thus, an of the method is to teach a child to create a window of time, e.g., for example a few minutes, preferably 2 minutes at least, by frustrating the purpose of the abductor and to cause indecision and to scare the abductor off, with the end result keeping the child safe and unabducted.

It is also preferred to teach a child that while performing the techniques taught in the training, to recognize the situation when a window of time may occur, e.g., a time when the abductor reaches indecision after his/her purpose is frustrated, when the child can make a run from the abductor. Often an abductor who recognizes that he/she is facing an uncontrollable child, who may have already frustrated the smooth going of the abduction, is not worth pursuing.

### BRIEF DESCRIPTION OF THE DRAWINGS

FIG. 1. Is a block diagram of a training area, and

FIG. 2. Is a block diagram of a training area set up as a course with teaching stations.

### DESCRIPTION OF THE INVENTION

A focus of the present invention is a training program that teaches a child techniques on how to outsmart an abductor with motor skills, obstacle positioning, and acting techniques.

The present invention contains seven techniques a child may use when encountering an abductor. Any number of these techniques may be used alone or together or in successive order to each other.

Technique 1:

Technique 1 is referred to as “the squirming worm.” This technique relies on the hard to handle theory. During training teach a child to use running patterns that include quick turns, forward and backwards motions, shifts in direction, etc. It is advantageous to teach a child to master these movements in a small and condensed area. This will force a child to both build endurance and to use more changes in running patterns. Additionally, a small area may simulate a real life situation where an abductor waits for a child to be in a small and secluded area, for example, a bathroom, before attempting to abduct him/her.

It is preferred to have the child keep arms in close to the body so as to not provide the opportunity for the abductor to grab onto the child's arm. The more changes in direction and more types of motions a child can use in a short period of time and distance, the better his/or her chance is to avoid being successfully grabbed and controlled by the abductor.

Mastering the squirm and worm technique comes with training and practice, as do many learned motions in sports, for example. Football players, for example, hold the ball close to their body, e.g., with arms close to the body to avoid being grabbed (and also to avoid losing the ball), and run, often in a congested area between other players, using quick turns, forward and backwards motions, and shifts in direction, etc. As do football players improve with training in running the ball, so do children improve in using similar running pattern techniques in avoiding an abductor.

An additional, advantageous technique a child can use in combination with any of the seven techniques is to be vocal, e.g., talking or preferably screaming, during the entire encounter with an abductor. This will alert others to recognize the abduction situation and come to help the child or alert others who can help the child. Bringing attention to the situation can alone scare off the abductor who in most situations does not wish to be caught.

Preferred language to be used by a child is “stranger, stranger,” “stranger, don't touch me,” “stranger, stranger, don't tough me there,” etc. A bystander overhearing these words will often recognize that these words come from a child facing an adult who he/she is not familiar with who is attempting to catch, touch, and/or abduct the child.

Technique 2:

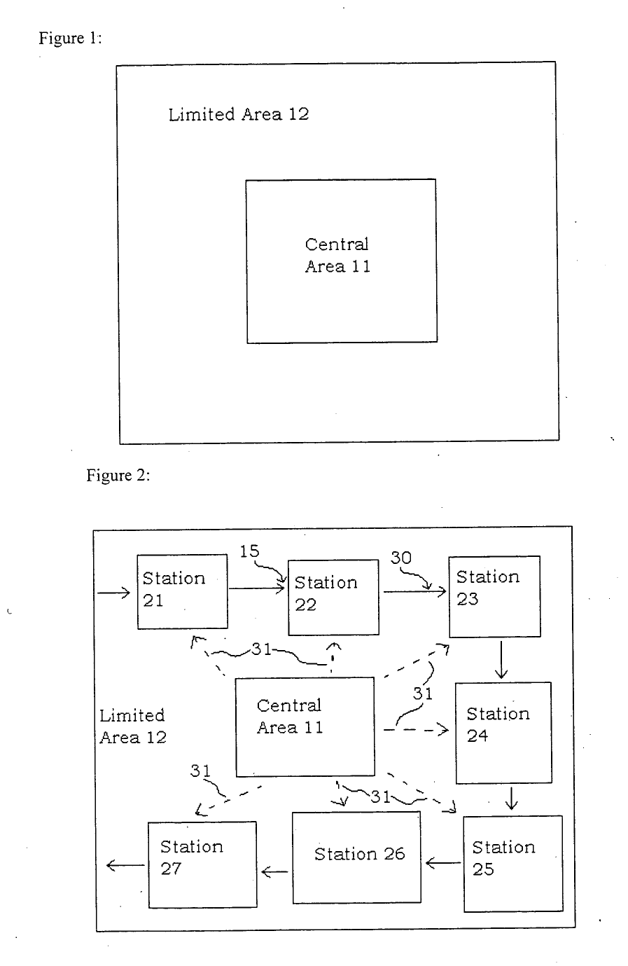

Technique 2 is referred to as the “sticky hands.” This technique relies on the super hero theory. (Super heroes have sticky hands and can hold onto things, climb walls, etc.) During training teach a child to how to create a strong lock between both hands and how to grab things. Preferably, one of two grips, which have been shown to be adequately strong when used by children, should be used. These grips are called the “latch” and the “cup.” In the latch grip, the right hand of the child grips the left wrist and the left hand grips the right wrist (see FIG. 1). In the “clap” grip, the palms of the two hands face each other at about a 90° angle, and the fingers and thumb are bend over the other hand to latch on (see FIG. 2).

Holding these grips around a fixed or movable object or another child while an abductor tries to move and carry away a child, has the effect of making the child seem heavier.

In a preferred method of using this technique, the child manages to hold one of the two preferred grips, once grabbed by the abductor, lowers his/her weight and starts pulling away from the abductor. This technique will make the child harder to move. Both the weight of the child and the strength of the child are more efficiently used in avoiding being moved when holding one of the preferred grips.

Technique 3:

Technique 3 is referred to as the “flapping fish:” This technique relies on the controlled chaos theory. During training teach a child how to flap around relentlessly so it is hard to grab them or pick them up. Preferably teach the child that the more they flap, struggle, etc., the better their chance of getting away from the abductor. Also preferably teach the child that it is important to be constantly a moving, flapping obstacle that makes it harder for an abductor to succeed.

In a preferred embodiment, the child should be taught to lye on his/her back and start flapping and kicking with feet and punching with hands in all directions possible. This way the abductor has difficulty grabbing the child at all. If the abductor succeeds in grabbing one of the child's arms or feet, the child is taught to direct at least some of the kicks and punches at the abductor, while still maintaining flapping or moving the body. Additionally a child is trained to simultaneously while being vocal, e.g., yell, “stranger, strange, don't touch me,” as described above.

In a preferred embodiment, this technique is used in combination with technique 1 and/or 2, e.g., have the child squirm away from the abductor, if the abductor grabs the child, use one of the grips from the sticky hands technique to hold onto another object while pulling away, if the child falls on the ground, the child starts flapping combined with kicking and punching in many directions. While practicing this combination of techniques, the child is taught to simultaneously scream “stranger, strange, don't touch me” or a similar phrase.

Technique 4:

Technique 4 is referred to as the “scooper.” Teach a child to grab objects or materials, for example, sand or stones, etc., from the ground and to throw them toward the abductors face and eyes. The child is taught that it is better to pick up with the palm as fingers are easily hurt. After the palm is over the object(s) to be picked up, the fingers can be used to grip the object(s). Preferably, the throw is from the chest, which is a hidden area when compared to an area away from the body. When a throw of object(s) unexpectedly originates from the body of the child, the abductor has a decreased chance of noticing the throw until it is too late to avoid the object(s). Grabbing object(s) from the ground can occur at any opportune time, for example, while the abductor is pulling the child away, if the child, whether on his feet or back, can grab object(s), such should be grabbed and thrown as described. The type of object(s) useful is not limited in any way. They can be sticks, stones, sand, toys, etc., and can be thrown at the abductor, preferably to an area, where it would create distraction, e.g., sand in the eyes, stick in the stomach, rock to the face or groin.

It is preferred to teach a child that using these techniques can hurt people and should be used only in situations where needed, e.g., when facing an abductor. It can be stressed that since abductors are usually bigger and stronger than their targets, these techniques are important in avoiding possible abduction.

During training, in place of objects such as sand and/or stones, safer alternatives should be used as objects, e.g., safe, soft, non-toxic objects that would not cause harm.

In preferred embodiments, this technique is used in combination with other techniques taught in this application, for example, the child can use the sticky hands technique, and at an opportune time while being pulled away, break the grip to reach to the ground to pick up and throw object(s) toward the abductor. If the abductor releases hold of the child, this may be an opportune time for the child to run from the abductor.

Technique 5:

Technique 5 is referred to as the “scream machine.” This technique relies on the attention draws attention theory. Train the child to draw attention to the abduction by screaming continuously for an extended amount of time. The longer the child continues screaming, the better the chance for the screaming is to attract attention to a person who may come to the aid of the child. The child is trained to scream continuously, for example, for 10, 15, or 30 seconds at a time. Periodic screams are usually not as attention grabbing as continuous screaming. Preferably, the child is trained to scream for more than 30 seconds continuously. This drill builds up their stress reflex and channels their negative fears into a positive cry for help. The screams preferably are terms, such as, ones described above, e.g., “stranger, strange, don't touch me.”

Technique 6:

Technique 6 is referred to as “the pretzel.” This technique relies on the lock on and hold theory. Teach a child to wrap safely around any object or each other and stay connected until help arrives, the abductor gives up, or a safe opportunity to escape presents itself. Explain to the child or children that by locking onto each other or an object such as a swing, bicycle, chair, bike rack, etc., that they will become unmovable or become hard to move obstacle, and thus, become hard to abduct.

In a preferred method, where more than one child is present, which may occur in situations where two or more children, for example, brothers or sisters or friends playing on a playground, the children are trained to use the sticky hands grips of Technique 2 to entangle their arms with one another to make the children less movable. An abductor facing two children, with arms entangled in strong grips, will have a difficult time moving the children. Preferably, the children once entangled, can lower they bodies to make them even less movable. The lowered body positions make the children seem heavier and bigger.

Teamwork should be stressed during training. The above-described preferred technique fails if once the abductor grabs a child, the other children instead of using their grips to hold onto the grabbed child run away.

A further option is to train the children to grab onto any object available, preferably using one of the sticky hands grips of Technique 2. This object can be any object available, e.g., a chair, bicycle, etc. Once a grip is established, the abductor instead of only having to carry the child, also has to carry the object the child is gripped onto. Both the size and the weight of any object gripped works toward the advantage of the child. For example, if the object is a chair, even if it is a light-weight plastic chair, the chair makes it more difficult for an abductor to place the child into a car since the chair may not fit into the car. A heavy object or one that is anchored to the ground, for example, a swing, or post may make it impossible for the abductor to move the child unless he/she is able to force the child to break the grip.

Technique 7:

Technique 7 is referred to as “acting in safety.” This technique relies on the deal with the moment theory. Teach the child how to become and instant actor or actress by getting the abductor to buy into a statement. This creates a distraction for the abductor and may get his/her focus off the abduction at least temporarily, giving the child an opportunity to use one of more of the techniques taught in this application and/or to run from the abductor. Examples of a useful statement, coupled with body language, may be, for the child to point direction and say “there is my dad.” Other options may be to point to the ground and point to a rock and say “isn't that a nice rock,” or “my shoe is loose I need to fix it.”

Examples of preferred combination of techniques include, for example, 1) a statement by the child that “my shoe is loose I need to fix it,” followed by the child lowering self to the ground and using the scooper technique to gather ground material and throw into the attackers eyes, after which the child can run and scream “stranger, stranger, don't touch me there,” or 2) a statement by the child that “look, there comes my dad,” with simultaneously the child pointing behind the abductor, i.e., his/her blindside, to get the abductor to look away and then using any of the other taught techniques to get away.

Repetition of the learned techniques leads a child to subconsciously have the correct response to an unexpected abduction situation. Thus, it is useful for a child to practice the techniques taught through training multiple times. The training can also be repetitiously performed to instill correct techniques in the child.

Additionally, it is important to note that the techniques presented here can be used together as described above in any combination, and can also be used together with other self defense techniques, for example, by kicking an abductor in the knees or shin at an opportune time.

It is equally important to note that the method includes teaching any of these techniques alone, independently of the other techniques described herein, but preferably, more than one of the techniques described herein are taught to a child to enable the child to effectively defend him- or her-self when facing abduction, e.g., the method preferably includes teaching, for example, at least any two, three, four, five or six, or all seven of the techniques in a training session.

The training program is preferably performed in, for example, a classroom setting, with one or more teachers teaching one or more child, by, for example, demonstrating the techniques of the program in person, through drawings and/or via a training video, and then having the child repeatedly perform the taught techniques. Training can also take place with a child and a trainer, e.g., a parent, one-on-one, preferably, with the aid of, for example, a training video that demonstrates the techniques of the training program.

Preferably, the trainer or one of the trainers if there is more than one simulates a real life situation in the method by taking on the role of the abductor (role-play) and tries to abduct, grab, or control a child's actions. Training is more effective when a child not only performs the techniques against an imaginary abductor, but against a real person simulating an abductor.

In a preferred embodiment, a classroom is adapted for teaching the techniques taught in this application, with, for example, soft mats on which the children practice the techniques. The soft mats can be color coded such that to outline a training course or represent a small and condensed area within which the techniques are to be performed by the children. The training course and small and condensed area do not require the presence of training mats as the techniques can be taught in any setting, for example, outdoors in a park, or in any adapted area which is suitable for the techniques.

Referring now to the drawings, FIG. 1 is a block diagram defining a limited area 10 in which a child performs the aforedescribed techniques. A trainer representing the abductor is preferably in a central area 11 while the child being trained is in the limited area 12 surrounding central area 11. A child when facing abduction, typically has to perform the techniques taught herein in the vicinity of the abductor, i.e., once the child is farther away from the abductor, the child may more easily and with more certainty of success increase the chances of escape from the abductor. Thus, the limited area 10 and surrounding area 11 effectively simulates an area where an abductor would be located in a real abduction situation in which a child performs the aforedescribed techniques if faced with abduction.

FIG. 2 is a block diagram illustrating a training course 15 within the limited area 10 adapted to a method of training taught herein. The training course 15 has seven stations 21-27 within the limited area 10 that surround the central area 10. In each of the seven stations 21-27 one of the aforedescribed seven techniques of the present invention is taught and practiced. A child traverses the course by starting at station 21 and progressing though to station 27 over a path 30 indicated by the arrows between the stations. An option is for a trainer to be positioned in the central area 11 for directing a child to one of the seven stations 21-27 at random as indicated by the dashed arrows 31 from area 28 to each area 21-27. In another approach, different trainer can be assigned to each area 21 to 27. Each child is repeatedly recycled through the training course 15 until the child responds reflexively to abduction situations.

From the foregoing description, one skilled in the art can easily ascertain the essential characteristics of this invention, and without departing from the spirit and scope thereof, can make various changes and modifications of the invention to adapt it to various usages and conditions.

We claim:

1. A method of training a child to avoid abduction comprising teaching the child when facing abduction to perform at least one of the following techniques: 1) the squirming worm, 2) sticky hands, 3) flapping fish, 4) scooper, 5) scream machine, 6) the pretzel, and 7) acting in safety.

2. A method according to claim 1, wherein at least three of the seven techniques are taught.

3. A method according to claim 1, wherein the training takes place on an area adapted for training, wherein the area contains a central area surrounded by a limited area.

4. A method according to claim 3, wherein a trainer is located in the central area and the child is located in the limited area.

5. A method according to claim 1, wherein the limited area contains a plurality of stations, wherein in each of the stations one of the techniques are taught.

6. A method according to claim 5, wherein a trainer is located in each of the stations.

7. A method of training a child to avoid abduction comprising:
providing an area having a plurality of spaced stations along a path, each station being associated with an abduction avoidance technique to a threat of abduction;
moving the child along paths from one station to the next and teaching the child the abduction avoidance technique associated with each station, and
repeating the steps of teaching the child until the child responds reflexing to the threats with the techniques taught.

8. The method of claim 7 wherein the child is initially moved sequentially from one station to another in accordance with a predetermined order.

9. The method of claim 8 wherein the child is moved randomly from one station to another after learning each of the techniques in sequence to practice each technique as a response to a specific threat.

10. The method of claim 7 wherein at least one of the techniques includes an audible response to a threat.

11. The method of claim 10 wherein the child is taught to perform the audible response technique simultaneously with other techniques.

12. The method of claim 11 wherein one of the techniques includes the child forming a loop with their arms by clasping their hands or clasping their hands with their wrist to prevent an abductor from grasping their hand, and then falling down so that the child must be dragged or carried by the abductor while the child performs an audible response.

13. The method of claim 11 wherein one the technique includes the child grasping another fixed or movable object or grasping another child in response to a threat by an abductor.

14. The method of claim 13 wherein the child is taught to form a loop with their arms by overlapping the fingers and thumb of each hand with the back of the other hand or by grasping the wrist of each arm with the fingers of hand on the other arm, the loop being formed around a fixed or movable object or with a similar loop formed by another child.

15. The method of claim 14 wherein one of the techniques that the child is taught is to run and dodge an abductor within a limited area while yelling for help loudly.

16. The method of claim 7 wherein at least one of the techniques the child is taught comprises the child punching and kicking at the abductor while lying down.

17. The method of claim 11 wherein one of the techniques includes teaching the child hurling objects or materials at the face of the abductor while the child is prone on its back.

18. The method of claim 1 wherein one of the techniques taught is to distract the abductor by referring to imaginary situations which are disruptive to plans of the abductor.
